(19) United States
(12) Patent Application Publication
(10) Pub. No.: US 2015/0033234 A1
(43) Pub. Date: Jan. 29, 2015

(54) PROVIDING QUEUE BARRIERS WHEN UNSUPPORTED BY AN I/O PROTOCOL OR TARGET DEVICE

(71) Applicant: QUALCOMM Incorporated, San Diego, CA (US)

(72) Inventors: Assaf Shacham, Zichron Yaakov (IL); Itai Lanel, London (GB); Maya Haim (Erez), Haifa (IL)

(21) Appl. No.: 14/338,235

(22) Filed: Jul. 22, 2014

Related U.S. Application Data
(60) Provisional application No. 61/857,570, filed on Jul. 23, 2013.

(51) Int. Cl. G06F 9/52

(52) U.S. Cl. CPC G06F 9/522
USPC 718/102

(57) ABSTRACT

A host controller is provided that unilaterally supports queue barrier functionality. The host controller may receive a first task marked with a queue barrier indicator. As a result, the host controller stalls transmission of the first task to a target device. Additionally, the host controller also stalls transmission of any task, occurring after the first task, to the target device. The host controller only sends the first task to the target device once an indication is received from the target device that all previously sent tasks have been processed. The host controller only sends any task, occurring after the first task, to the target device once an indication is received from the target device that the first task has been processed.

### Claim Of Priority Under 35 U.S.C. §119

The present utility patent application claims priority to U.S. Provisional Patent Application No. 61/857,570 entitled “Providing Queue Barriers When Unsupported By An I/O Protocol or Target Device”, filed Jul. 23, 2013, which is assigned to the assignee hereof and hereby expressly incorporated by reference herein.

### FIELD

The following relates generally to task execution within a queue, and more specifically to methods and devices for providing or facilitating queue barriers when such queue barriers are unsupported by an input/output (I/O) protocol in use.

### BACKGROUND

Software operating within an I/O host controller in a host device may queue a number of tasks which are sent by the I/O host controller to a target I/O device for queuing and execution. In some cases, the order of execution may be determined by the receiving target I/O device, which is beyond the control of the host device. So, the receiving target I/O device may change the order of execution of tasks.

In some cases, software on the host device would like to guarantee a certain order of execution of tasks sent to the target I/O device. For example, some I/O communication protocols provide queue barriers that serve to indicate whether a task cannot be processed out of sequence. In other cases, the target I/O device and/or I/O communication protocol (used between the host device and target I/O device) may not provide hooks for enforcing such order of execution.

Consequently, there is a need to provide queue barrier functionality that permits a host device to control the order of execution at a target I/O device in situations where such functionality is unsupported by a target I/O device or I/O communication protocol.

### SUMMARY

A host controller is provided, comprising a communication interface to communicate with a target device and a processing circuit coupled to the communication interface. The processing circuit may be adapted to: (a) obtain a first task marked with a queue barrier indicator; (b) stall transmission of the first task to the target device; and/or (c) send the first task to the target device once an indication is received from the target device that all previously sent tasks have been processed.

In one example, the processing circuit may be further adapted to: (a) sequentially obtain multiple tasks from a task queue, wherein the first task is among the multiple tasks; (b) ascertain whether each task is marked with a queue barrier indicator; and/or (c) determine that the first task is marked with the queue barrier indicator.

Additionally, the processing circuit may be further adapted to stall transmission of any task, occurring after the first task, to the target device until the indication is received from the target device that all previously sent tasks have been processed. The processing circuit may then send any task, occurring after the first task, to the target device once an indication is received from the target device that the first task has been processed.

In one implementation, the host controller and target device may communicate using a protocol in which queue barrier indicator functionality is unsupported. According to one aspect, a separate queue barrier indicator functionality is unsupported in the target device. According to another aspect, the queue barrier indicator may be distinct from a separate queue barrier functionality supported in the target device or an input/output communication protocol between the host controller and target device.

In one implementation, the host controller may be a separate device from the target device. In another implementation, the host controller may be integrated with the target device in a single semiconductor device. In one example, the target device may be a storage device and the tasks include read and/or write operations.

The first task may be sent to the target device without the queue barrier indicator. The first task and other tasks may be obtained by the processing circuit from a task queue, and each of the first task and other tasks are processed by the processing circuit in the order in which each task is placed in the task queue relative to other tasks marked with a queue barrier indicator.

A method operational on a host controller is also provided for communicating with a target device, comprising: (a) obtaining a first task marked with a queue barrier indicator; (b) stalling (e.g., suspending, temporarily stopping) transmission of the first task to the target device; (c) sending the first task to the target device once an indication is received from the target device that all previously sent tasks have been processed.

The method may further comprise: (a) sequentially obtaining multiple tasks from a task queue, wherein the first task is among the multiple tasks; (b) ascertaining whether each task is marked with a queue barrier indicator; (c) determining that the first task is marked with the queue barrier indicator; and/or (d) stalling transmission of any task, occurring after the first task, to the target device until the indication is received from the target device that all previously sent tasks have been processed. Any task, occurring after the first task, may be sent to the target device once an indication is received from the target device that the first task has been processed.

In one example, the host controller and target device may communicate using a protocol in which queue barrier indicator functionality is unsupported. In another example, the queue barrier indicator may be distinct from a separate queue barrier functionality supported in the target device or an input/output communication protocol between the host controller and target device. In yet another example, queue barrier indicator functionality is unsupported in the target device.

A non-transitory processor-readable storage medium is provided having one or more instructions which, when executed by at least one processing circuit, cause the at least one processing circuit to: (a) obtain a first task marked with a queue barrier indicator; (b) stall transmission of the first task to the target device; (c) send the first task to the target device once an indication is received from the target device that all previously sent tasks have been processed; and/or (d) stall transmission of any task, occurring after the first task, to the target device until the indication is received from the target device that all previously sent tasks have been processed.

The non-transitory processor-readable storage medium may further include one or more instructions which, when executed by at least one processing circuit, cause the at least one processing circuit to: (a) sequentially obtain multiple tasks from a task queue, wherein the first task is among the multiple tasks; (b) ascertain whether each task is marked with a queue barrier indicator; and/or (c) determine that the first task is marked with the queue barrier indicator. Any task, occurring after the first task, may be sent to the target device once an indication is received from the target device that the first task has been processed.

### DRAWINGS

FIG. 1 is a block diagram of a system comprising a host device coupled to a target I/O device via a bus and adapted to implement queue barrier functionality.

FIG. 2 is a flow diagram illustrating how a queue barrier function may be implemented.

FIG. 3 (comprising FIGS. 3A, 3B, and 3C) graphically illustrates processing of an exemplary implementation of a queue barrier indicator on a host device.

FIG. 4 is a flow diagram illustrating a method operational by a host controller to implement a queue barrier for tasks.

FIG. 5 is a block diagram illustrating an exemplary of a host device implementing host-controlled queue barrier functionality.

FIG. 6 is a flow diagram illustrating an exemplary method operational at a host device for implementing queue barrier functionality.

FIG. 7 is a block diagram illustrating an exemplary host controller adapted to facilitate queue barrier functionality.

FIG. 8 is a flow diagram illustrating an exemplary method operational by a host controller adapted to facilitate queue barrier functionality.

FIG. 9 is another flow diagram illustrating an exemplary method operational by a host controller adapted to facilitate queue barrier functionality.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of telecommunication systems, network architectures, electronic device, mobile devices, computing devices, and communication standards. Certain aspects of the disclosure are described below with reference to specific protocols, systems, and technologies. However, those of ordinary skill in the art will recognize that one or more aspects of the present disclosure may be employed and included in one or more other wireless communication protocols, systems, and technologies.

Overview

Various features and aspects of the present disclosure pertain to guaranteeing that tasks are executed in a certain ordering even where a receiving target device or interface protocol does not provide support for such queue ordering. A host software operating on a host device may mark a certain task with a Queue Barrier (QBR) indicator (e.g., tag or marker). However, a target I/O device with which the host device communicates and/or the I/O communication protocol used may not support such QBR indicator. Consequently, when the host I/O controller processes a task that is tagged/marked with a QBR indicator, it does not send it to the target I/O device until all the tasks which were previously queued (at the target I/O device) are executed. The target I/O device may send an execution acknowledgement to the host I/O controller as each task is executed or processed. The host I/O controller at the host device may also stall/hold all tasks which are queued after the QBR marked task and pass them to the target I/O device only after the QBR marked task is executed. Thus, a queue barrier may be implemented in the host I/O controller of the host device as part of the I/O interface. For instance, such queue barrier at the host I/O controller may be useful where queue barriers are not natively supported by the I/O communication protocol and/or the target I/O device. In other instances, such queue barrier at the host I/O controller may be useful even if the I/O communication protocol supports queue barriers. For example, there may be cases where even if the I/O communication protocol supports queue barriers, it may still be desirable to allow the host I/O controller to implement queue barriers as well, such as when the I/O communication protocol may not allow sending of a queue barrier command while others are still in progress This concept contemplates one or more QBR marked/tagged tasks being used at any one moment (i.e., simultaneously) in a queue.

Exemplary Operating Environment

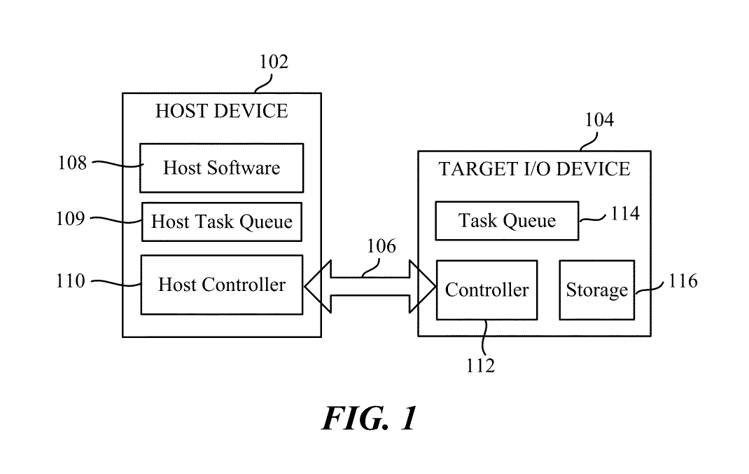

FIG. 1 is a block diagram of a system comprising a host device 102 coupled to a target I/O device 104 via a bus 106 and adapted to implement queue barrier functionality. The host device 102 may include host software 108, a task queue 109, and a host controller 110. The target I/O device 104 may include a controller 112, a task queue, and a storage device 116. The host task queue 109 may hold the tasks being sent to the target I/O device 104. For instance, such host task queue 109 may be used by the host software 108 to provide tasks to the host controller 110 and may be used to hold the tasks until they are sent to the target I/O device 104.

In various implementations, the target I/O device 104 may be a distinct or separate component from the host device or the target I/O device 104 may be integrated as part of a single semiconductor chip along with the host device 102. For example, the target I/O device 104 may be a flash storage device that is compliant with the Embedded Multi-Media Controller (eMMC) standard by the Joint Electron Device Engineering Council (JEDEC). Queue barriers are sometimes defined by protocols to allow an order of execution to be defined for a task relative to other tasks. However, this only works when a target I/O device recognizes and complies with the execution order defined by such barrier tag/marker.

According to one approach, the host software 108 may generate a task that should be executed in certain order relative to other tasks. For example, a first task must be executed before all subsequent tasks. Consequently, the host software 108 may mark the first task with a queue barrier (QBR) indicator (e.g., a tag, marker, or bit) to indicate that the first task should be executed in a certain order relative to other tasks (e.g., first task must be executed after all tasks issued before it and/or the first task must be executed before all tasks issued after it, etc.). The host controller 110 may recognize that the first task is marked with a QBR indicator. Therefore, the host controller 110 may stall or hold the first task instead of sending it to the target I/O device 104 until an acknowledgement or indication is received that all prior tasks have been executed by the target I/O device 104. Likewise, the host controller 110 may stall or hold all subsequent tasks, instead of sending them to the target I/O device 104. Once the host controller 104 receives an indication that all preceding tasks have been executed by the target I/O device 104, it sends the first task to the target I/O device 104. The host controller 110 then waits to receive an indication that the first task has been executed by the target I/O device 104 prior to sending the subsequent tasks to the target I/O device 104. Note that the “task” disclosed herein may be data and/or non-data tasks (e.g., commands, instructions, etc.). In one example, the tasks may include read and/or write operations.

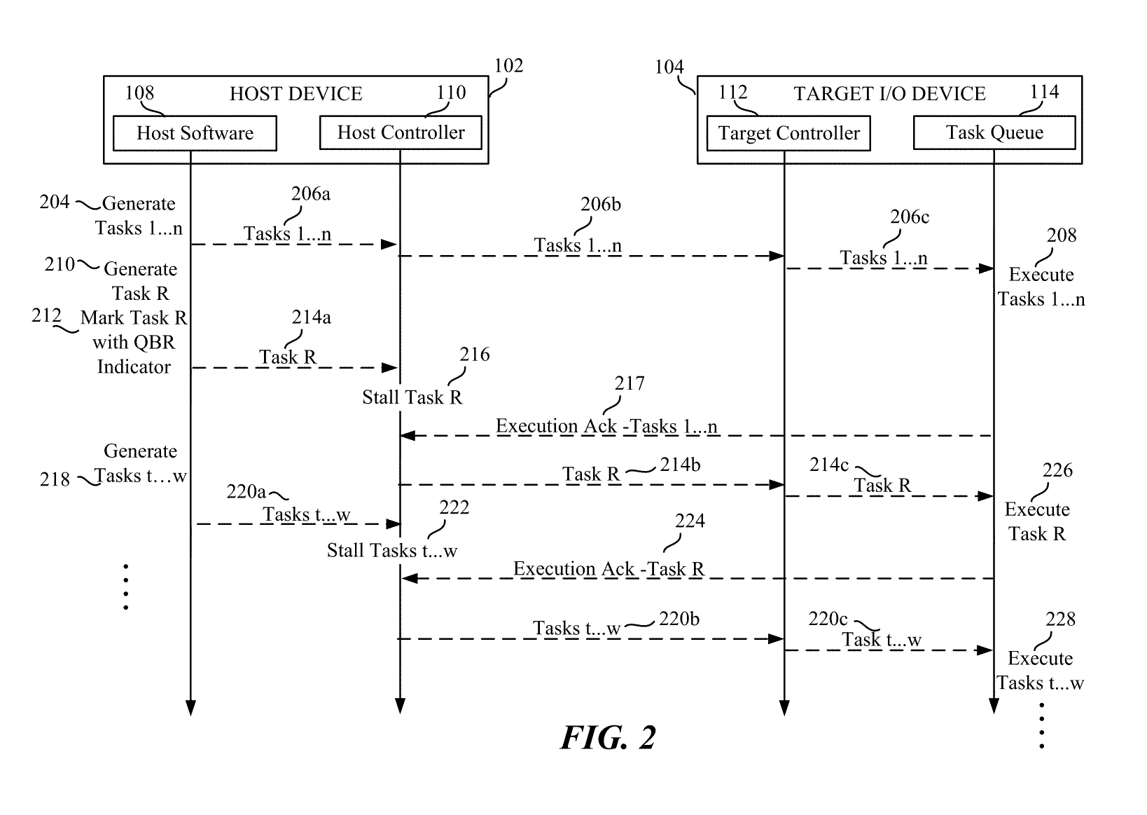

FIG. 2 is a flow diagram illustrating how a queue barrier function may be implemented. The host software 108 may generate tasks 1 . . . n 204 and provide them to the host controller 110. The host controller 110 then sends the tasks 1 . . . n to the target controller 112 which provides them to the task queue 114 from where they can be executed or processed 208.

The host software 108 may also generate a task R 210 that is marked with a queue barrier indicator 212 (e.g., marker or tag). The task R is provided to the host controller 110. However, because the task R is tagged/marked as QBR, the host controller 110 stalls or holds task R 216. The host controller 110 waits for acknowledgement from the target I/O device 104 that all previously sent tasks have been executed or processed. Upon receiving an acknowledgement 217 that tasks 1 . . . n have been executed or processed by the target I/O device 104, the host controller 110 sends the task R to the target controller 112. Note that, in some implementations, the acknowledgement that tasks 1 . . . n have been executed or processed may be sent while the last task (i.e., task n) is being processed but such processing has not been completed yet. From the target controller 112, the task R is passed to the task queue 114 from where it is processed or executed 226.

In the meantime, the host controller 110 stalls or holds 222 any tasks t . . . w 218 generated after task R until it receives acknowledgement that task R has been executed or processed by the target I/O device 104. Upon receiving an acknowledgement 224 that task R has been executed or processed by the target I/O device 104, the host controller 110 sends the tasks t . . . w to the target controller 112, which passes it to the task queue 114 from where they may be processed or executed 228.

In this manner, the host controller 110 is able to unilaterally implement queue barriers for tasks even when a target I/O controller and/or I/O protocol does not support queue barriers. Consequently, task execution ordering can be implemented by the host controller 110.

Note that one or more QBR marked/tagged tasks may be used at any one moment (i.e., simultaneously) in a task queue. Consequently, multiple tasks tagged/marked as QBR may be placed in the host device queue, each QBR marked/tagged task being sent to the target I/O device in the order in which it is placed in the host device task queue.

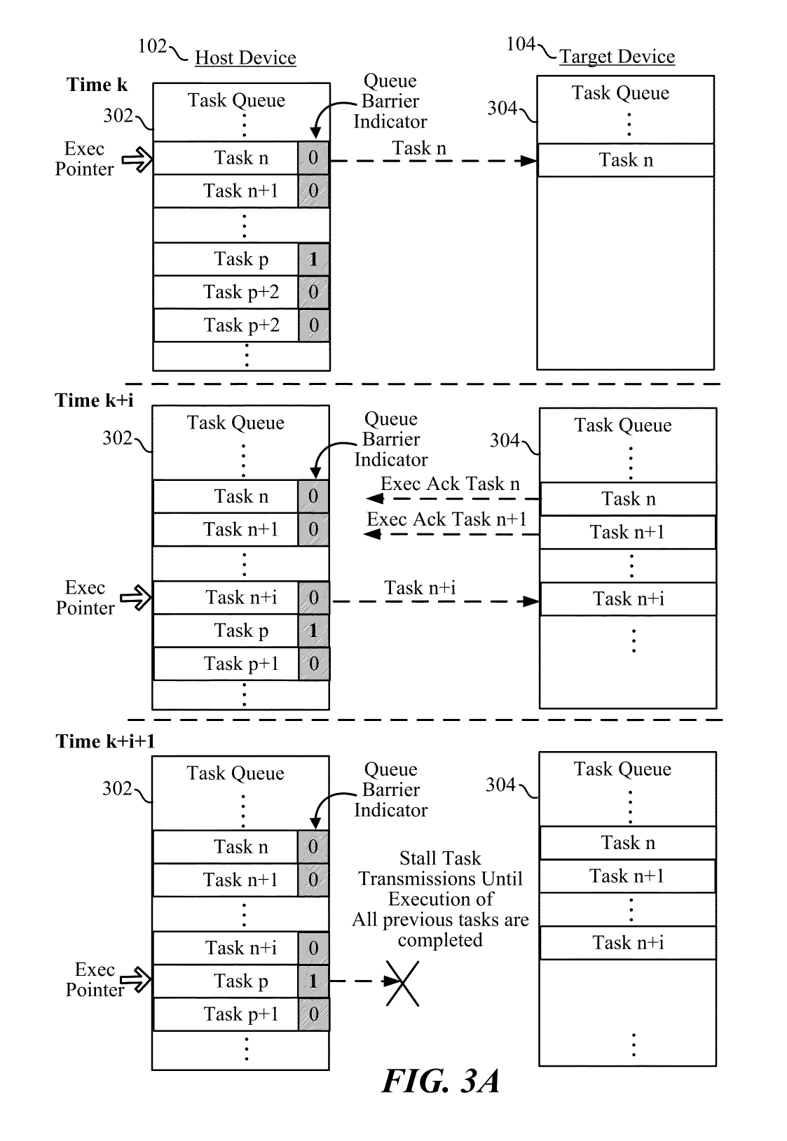

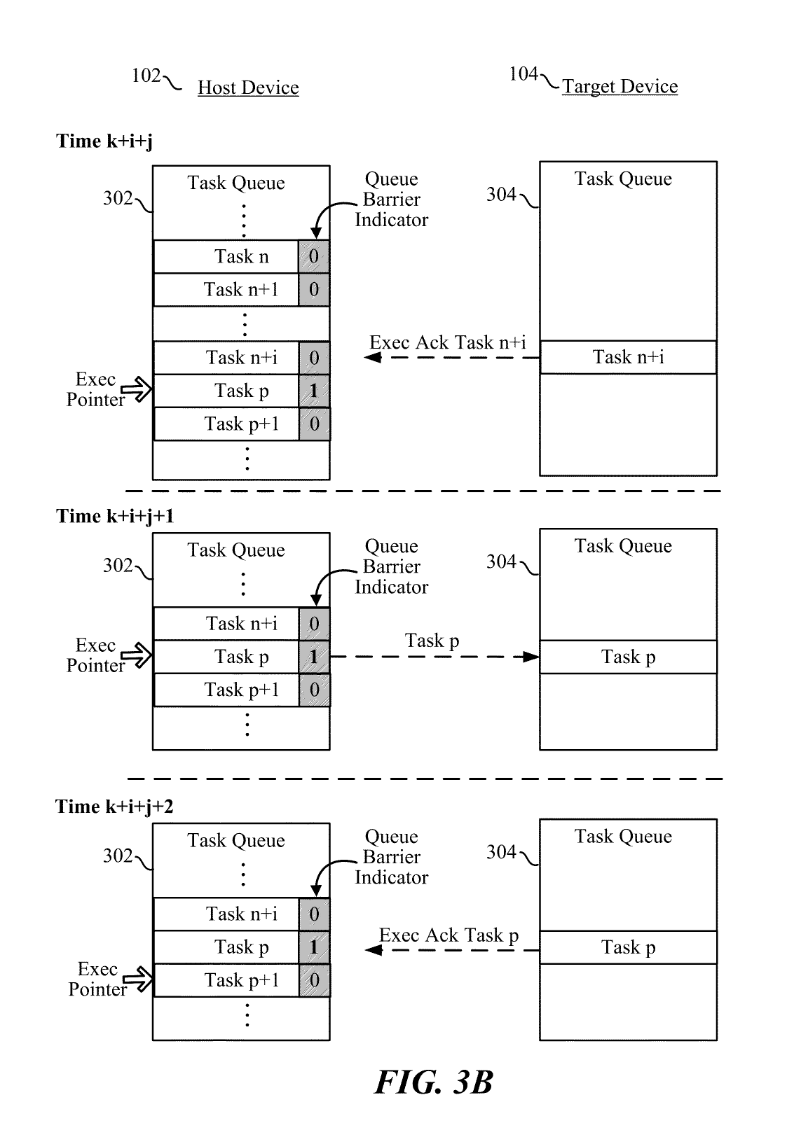

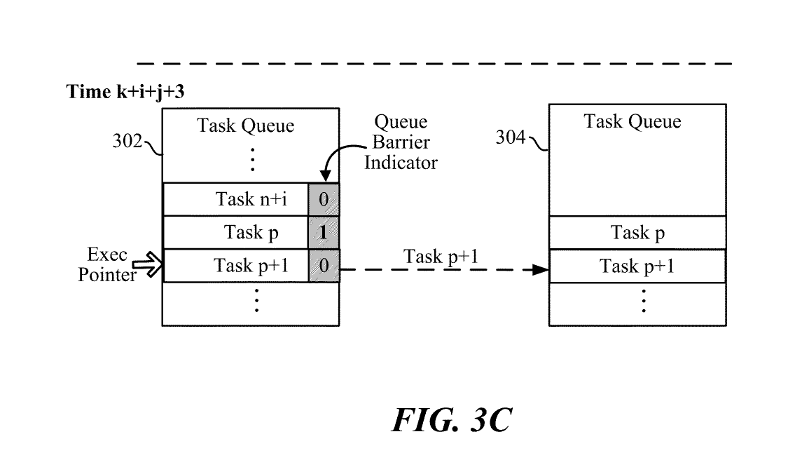

FIG. 3 (comprising FIGS. 3A, 3B, and 3C) graphically illustrates processing of an exemplary implementation of a queue barrier indicator on a host device. The host device 102 may implement a first task queue 302 in which tasks are placed for processing by the host controller 110. A target device 104 may similarly implement a second task queue 304 in which tasks received by the target controller 112 are placed for processing by the target device 104.

The tasks in the first task queue 302 may be tagged or marked with a queue barrier indicator. For instance, a queue barrier indicator=“0” indicates no queue barrier while a queue barrier indicator=“1” indicates a queue barrier. The host controller 110 may check the queue barrier indicator for each task prior to executing or processing each task. If a queue barrier indicator=“0” for a particular task, the host controller processes the task. Otherwise, if the queue barrier indicator=“1” for a particular task, the host controller stalls or halts processing of that task (and possibly all subsequent tasks) until it receives an indication or acknowledgement that all previously sent tasks have been processed by the target device 104.

At a time k, the host controller 110 may execute or process a Task n+i by sending the Task n to the target device 104 where it is placed into the second task queue 304. As the target device 104 processes each task, it may send an execution acknowledgment for each task to the host device 102.

At a time k+i, the host controller 110 may execute or process a Task n+i by sending the Task n+i to the target device 104 where it is placed into the second task queue 304.

At a time k+i+1, the host controller 110 may be ready to execute or process a Task p. Upon checking the queue barrier indicator for the Task p, the host controller detects that it is enabled or set to “1”, indicating a queue barrier is being asserted for Task p. Consequently, the host controller 110 halts or stalls processing of Task p (and all subsequent tasks) until it receives an acknowledgement or indication that all previously tasks sent to the target device 104 have been processed.

By time k+i+j, the host controller 110 may have received acknowledgements that all previous tasks, including Task n+i, have been executed or processed by the target device 104. Consequently, at time k+i+j+1 the host controller 110 may process Task p. The host controller 110 may stall all subsequent tasks until an indication or acknowledgement that the Task p (i.e., the task with the queue barrier indicator) has been processed by the target device. At time k+i+j+2, the host controller 110 may receive an execution acknowledgement for Task p. Then, at time k+i+j+3 the host controller 110 may process a subsequent Task p+1 and so on.

Note that, in one example, the queue barrier indicator may be a bit appended to each task. In another example, the queue barrier indicator for each task may be maintained in a separate memory segment.

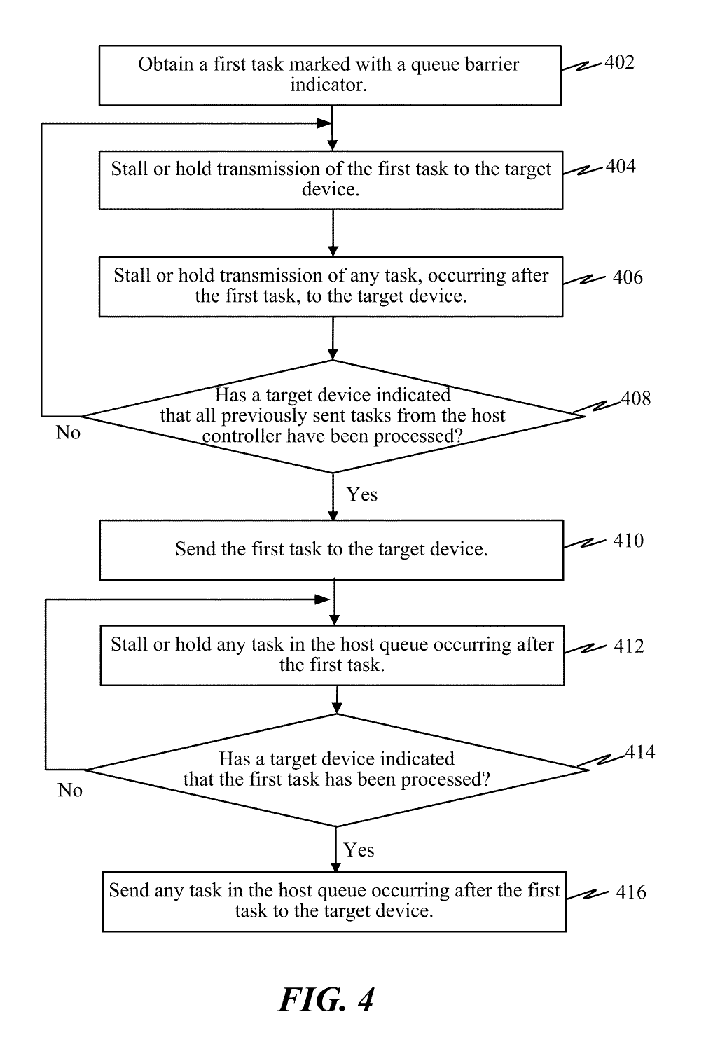

FIG. 4 is a flow diagram illustrating a method operational by a host controller to implement a queue barrier for tasks. This method may be implemented, for example, by the host controller 110 illustrated in FIGS. 1, 2 and 3. The host controller may include a communication interface through which it communicates with a target device. A processing circuit within the host controller may be adapted to: (a) obtain a first task marked with a queue barrier indicator 402; (b) stall transmission of the first task to the target device 404; (c) stall transmission of any task, occurring after the first task, to the target device 406; (d) send the first task to the target device 410 once an indication is received from the target device that all previously sent tasks have been processed 408; and/or (e) send any task, occurring after the first task, to the target device 416 once an indication is received from the target device that the first task has been processed 414. Otherwise, any task, occurring after the first task, is stalled 412 until such indication is received. Note that, in some implementations, the queue barrier indicator is not sent to the target device.

In some implementations, the host controller and target device may communicate using a protocol in which queue barrier indicator functionality is unsupported. Additionally, queue barrier indicator functionality may also be unsupported in the target device. The host controller may be integrated with the target device in a single semiconductor device. In one example, the target device may be a storage device (e.g., non-volatile storage, volatile storage, flash storage, etc.).

Exemplary Host Device

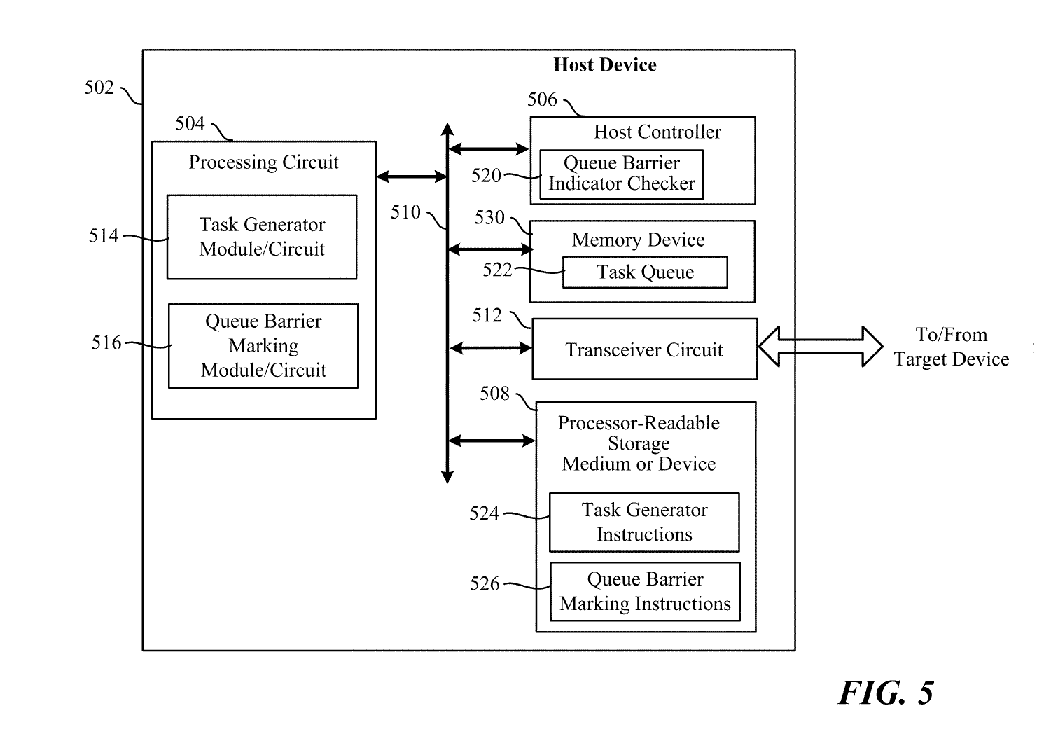

FIG. 5 is a block diagram illustrating an exemplary of a host device implementing host-controlled queue barrier functionality. The host device 502 may include a processing circuit 504, a host controller 506, a processor-readable storage medium/device 508, a memory device 530, a transceiver circuit 512, and a bus 510.

The processing circuit 504 may include a task generator module/circuit 514 adapted to generate one or more tasks and place the tasks in a task queue 522 within a shared memory device 530. The processing circuit 504 may also include a queue barrier marking module/circuit 516 adapted to mark one or more tasks with a queue barrier indicator as indicated by an operating system, host software, or compiler. In one example, the processor-readable storage medium device 508 may include task generator instructions 524 and queue barrier marking instructions 526 to permit host software operating on the processing circuit 504 to perform such functions.

The host controller 506 may obtain tasks from a task queue 522 within the memory device 530. A queue barrier indicator checker 520 may check each task prior to execution to ascertain if a queue barrier indicator is set for that particular task. If no queue barrier indicator is set for the task, the host controller 506 may process the task, e.g., sends the task (e.g., data and commands) to a target device via the transceiver circuit 512. If the queue barrier indication is set (e.g., “1”) for the task, the host controller 506 may stall, suspend, or halt execution or processing of the task and all subsequent tasks. In one example, the tasks may include read and/or write operations to be performed on the target device.

The host controller 506 may maintain status information for the tasks being processed. The target device may send an acknowledgement to the host controller 506 for each task the target device has processed. Upon receiving an indication that all previous tasks have been processed, the host controller 506 may process (e.g., send) the suspended or halted task and all subsequent tasks.

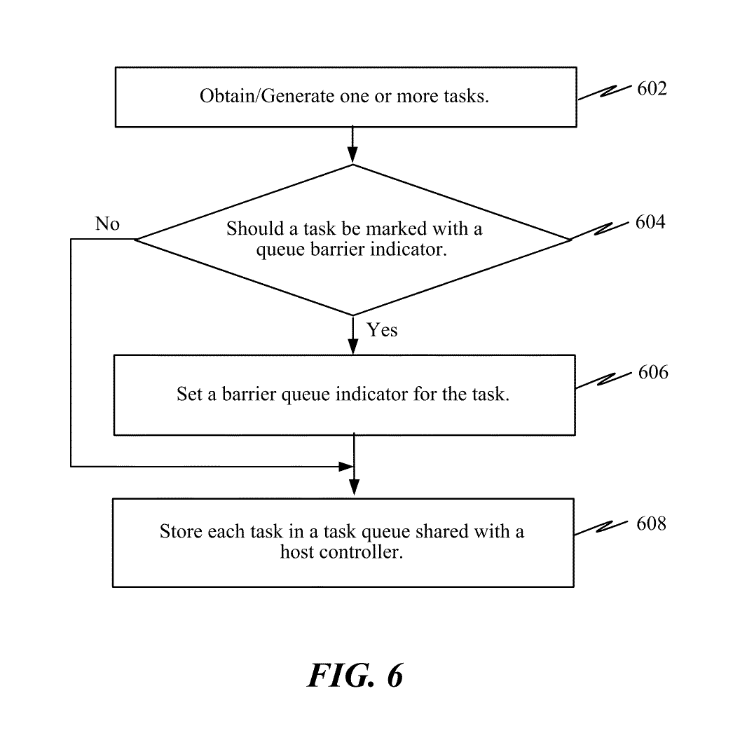

FIG. 6 is a flow diagram illustrating an exemplary method operational at a host device for implementing queue barrier functionality. Host software operating on the host device may obtain or generate one or more tasks 602. For each task, the host software may ascertain whether the task should be marked with a queue barrier indicator 604. If so, the barrier queue indicator for the task is set or enabled 606. Each task is then stored in a task queue shared with a host controller 608.

Exemplary Host Controller

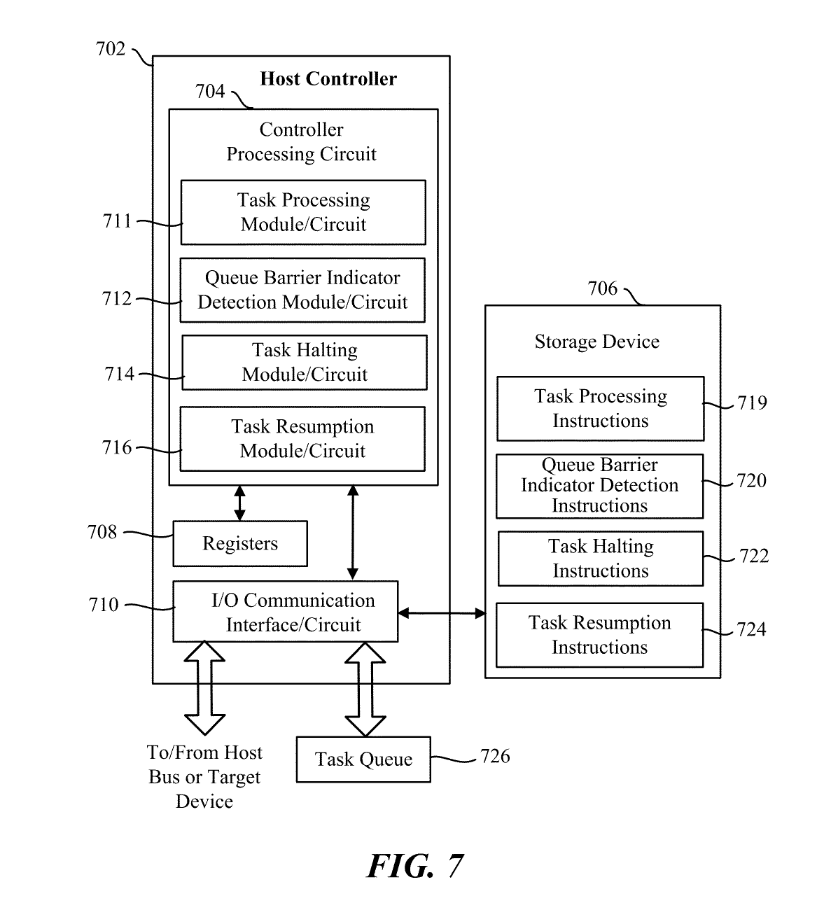

FIG. 7 is a block diagram illustrating an exemplary host controller adapted to facilitate queue barrier functionality. In this example, the host controller 702 may include a controller processing circuit 704 coupled to one or more registers 708, and/or an input/output communication interface or circuit 710. The controller processing circuit 704 may include a task processing module/circuit 711, a queue barrier indicator detection module/circuit 712, a task halting module/circuit 714, and/or a task resumption module/circuit 716.

The task processing module/circuit 711 may retrieve a task from a task queue 726, process the retrieved task, and then process the next task in the task queue 726. Such tasks may include, for example, performing read or write operations from/to an external target device. The queue barrier indicator detection module/circuit 712 may ascertain if a particular task is marked or tagged with a queue barrier indicator prior to processing of that task. If a queue barrier indicator is detected for a particular task, the task halting module/circuit 714 may freeze, halt, or suspend processing of the task and subsequent tasks (e.g., halt processing of a current task and any subsequent tasks pending in the task queue). The task resumption module/circuit 716 may monitor completion of previous tasks at the target device and, upon receiving an indication that all previous tasks have been processed by the target device, resumes processing of the tasks in the task queue.

In one example, the host controller 702 may be coupled to a storage device 706 (e.g., via the I/O interface circuit 710 in order to obtain one or more operating instructions. For example, the storage device 706 may include task processing instructions 719 to process tasks from the task queue 726, queue barrier indicator detection instructions 720 to detect the existence or occurrence of a barrier indicator, task halting instructions 722 to halt processing of tasks from the task queue when a barrier indicator is detected, and/or task resumption instructions 724 to resume processing of tasks once the barrier indicator has been cleared.

In one example, input/output communication interface or circuit 710 may serve to communicatively couple the controller processing circuit 704 to a bus through which it couples to a transceiver circuit to/from the target device. Alternatively, the input/output communication interface or circuit 710 may directly couple the controller processing circuit 704 to the target device.

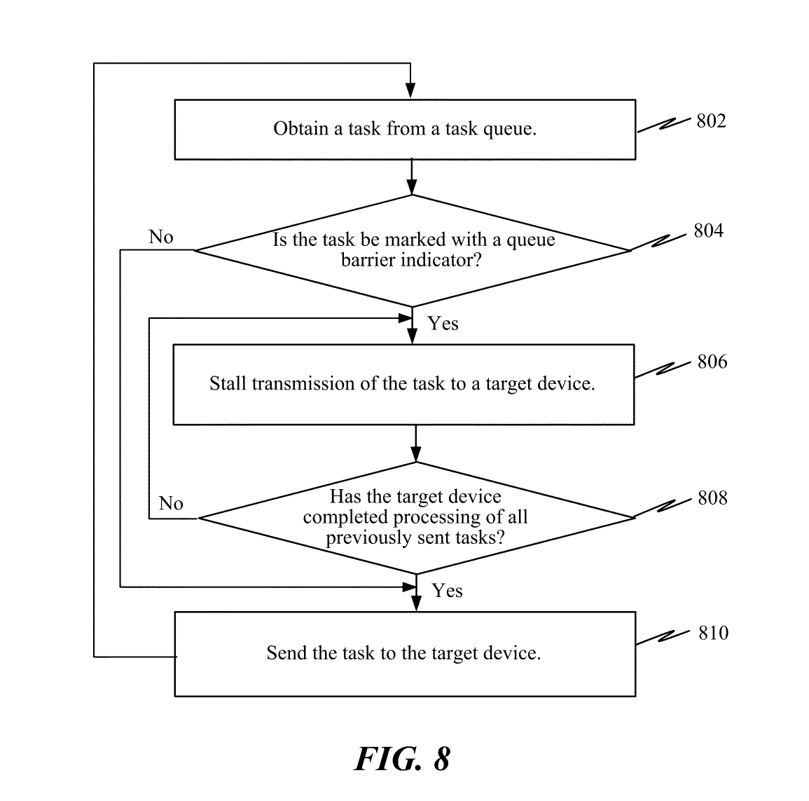

FIG. 8 is a flow diagram illustrating an exemplary method operational by a host controller adapted to facilitate queue barrier functionality. The host controller may obtain a task from a task queue 802. The host controller than ascertains if the task is marked with a queue barrier indicator 804. If so, then the host controller stalls transmission of the task to a target device 806. Once the host controller receives an indication that the target device has completed processing of all previously sent tasks 808, the host controller sends the task to the target device 810. This process may be repeated for each task in the task queue.

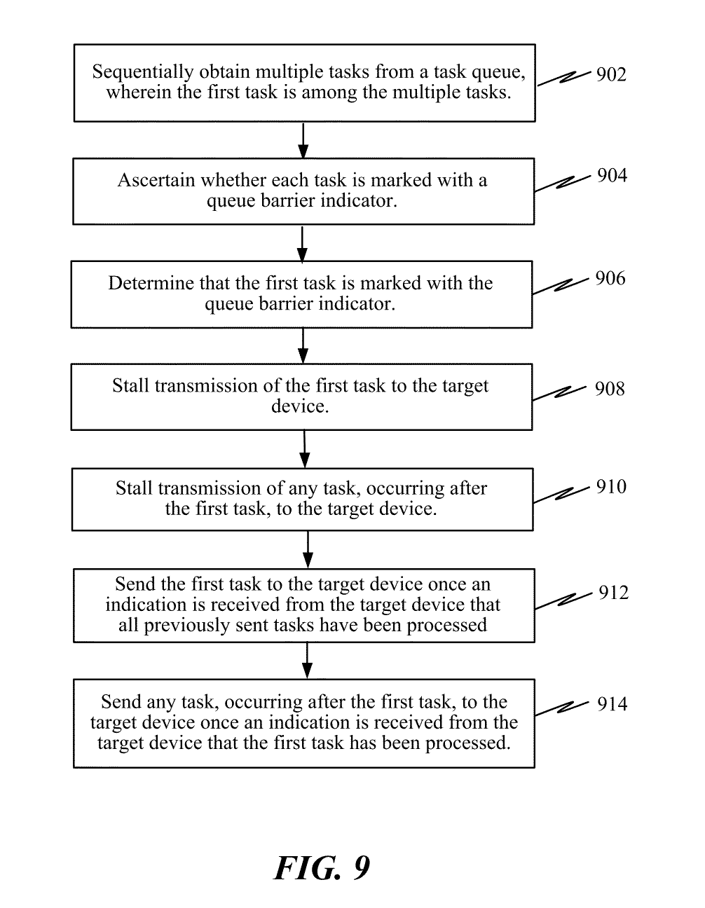

FIG. 9 is another flow diagram illustrating an exemplary method operational by a host controller adapted to facilitate queue barrier functionality. The host controller may sequentially obtain multiple tasks from a task queue, wherein a first task is among the multiple tasks 902. As each task is obtained or retrieved, the host controller may ascertain whether each task is marked with a queue barrier indicator 904. For instance, it may be determined that the first task is marked with the queue barrier indicator 906. Consequently, the host controller stalls transmission of the first task to the target device 908. Likewise, the host controller may also stall transmission of any task, occurring after the first task, to the target device until the indication is received from the target device that all previously sent tasks have been processed 910. The first task is sent to the target device once an indication is received from the target device that all previously sent tasks have been processed 912. Any task, occurring after the first task, may be sent to the target device once an indication is received from the target device that the first task has been processed 914.

In one example, the host controller and target device communicate using a protocol in which queue barrier indicator functionality is unsupported. In another example, the queue barrier indicator functionality is unsupported in the target device. In yet another example, the queue barrier indicator may be distinct from a separate queue barrier functionality supported in the target device or an input/output communication protocol between the host controller and target device.

In one implementation, the host controller may be a separate device from the target device. In another implementation, the host controller may be integrated with the target device in a single semiconductor device. In yet another implementation, the target device is a storage device and the tasks include read and/or write operations. According to one aspect, the first task is sent to the target device without the queue barrier indicator.

While the above discussed aspects, arrangements, and embodiments are discussed with specific details and particularity, one or more of the components, steps, features and/or functions illustrated in FIGS. 1, 2, 3, 4, 5, 6, 7 and/or 8 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, 3, 5, and/or 7 may be configured to perform or employ one or more of the methods, features, parameters, and/or steps described in FIGS. 2, 3, 4, 6 and/or 8. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a non-transitory machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A host controller, comprising:
a communication interface to communicate with a target device;
a processing circuit coupled to the communication interface, the processing circuit adapted to:
obtain a first task marked with a queue barrier indicator;
stall transmission of the first task to the target device;
send the first task to the target device once an indication is received from the target device that all previously sent tasks have been processed.

2. The host controller of claim 1, wherein the processing circuit is further adapted to:
sequentially obtain multiple tasks from a task queue, wherein the first task is among the multiple tasks;
ascertain whether each task is marked with a queue barrier indicator; and
determine that the first task is marked with the queue barrier indicator.

3. The host controller of claim 1, wherein the processing circuit is further adapted to:
stall transmission of any task, occurring after the first task, to the target device until the indication is received from the target device that all previously sent tasks have been processed.

4. The host controller of claim 3, wherein the processing circuit is further adapted to:
send any task, occurring after the first task, to the target device once an indication is received from the target device that the first task has been processed.

5. The host controller of claim 1, wherein the host controller and target device communicate using a protocol in which queue barrier indicator functionality is unsupported.

6. The host controller of claim 1, wherein a separate queue barrier indicator functionality is unsupported in the target device.

7. The host controller of claim 1, wherein the queue barrier indicator is distinct from a separate queue barrier functionality supported in the target device or an input/output communication protocol between the host controller and target device.

8. The host controller of claim 1, wherein the host controller is a separate device from the target device.

9. The host controller of claim 1, wherein the host controller is integrated with the target device in a single semiconductor device.

10. The host controller of claim 1, wherein the target device is a storage device and the tasks include read and/or write operations.

11. The host controller of claim 1, wherein the first task is sent to the target device without the queue barrier indicator.

12. The host controller of claim 1, wherein the first task and other tasks are obtained by the processing circuit from a task queue, and each of the first task and other tasks are processed by the processing circuit in the order in which each task is placed in the task queue relative to other tasks marked with a queue barrier indicator.

13. A method operational on a host controller for communicating with a target device, comprising:
obtaining a first task marked with a queue barrier indicator;
stalling transmission of the first task to the target device;
sending the first task to the target device once an indication is received from the target device that all previously sent tasks have been processed.

14. The method of claim 13, further comprising:
sequentially obtaining multiple tasks from a task queue, wherein the first task is among the multiple tasks;
ascertaining whether each task is marked with a queue barrier indicator; and
determining that the first task is marked with the queue barrier indicator.

15. The method of claim 14, further comprising:
stalling transmission of any task, occurring after the first task, to the target device until the indication is received from the target device that all previously sent tasks have been processed.

16. The method of claim 15, further comprising:
sending any task, occurring after the first task, to the target device once an indication is received from the target device that the first task has been processed.

17. The method of claim 13, wherein the host controller and target device communicate using a protocol in which queue barrier indicator functionality is unsupported.

18. The method of claim 13, wherein the queue barrier indicator is distinct from a separate queue barrier functionality supported in the target device or an input/output communication protocol between the host controller and target device.

19. The method of claim 13, wherein queue barrier indicator functionality is unsupported in the target device.

20. A non-transitory processor-readable storage medium having one or more instructions which, when executed by at least one processing circuit, cause the at least one processing circuit to:
obtain a first task marked with a queue barrier indicator;
stall transmission of the first task to the target device;
send the first task to the target device once an indication is received from the target device that all previously sent tasks have been processed.

21. The non-transitory processor-readable storage medium of claim 20, further having one or more instructions which, when executed by at least one processing circuit, cause the at least one processing circuit to:
sequentially obtain multiple tasks from a task queue, wherein the first task is among the multiple tasks;
ascertain whether each task is marked with a queue barrier indicator; and
determine that the first task is marked with the queue barrier indicator.

22. The non-transitory processor-readable storage medium of claim 20, further having one or more instructions which, when executed by at least one processing circuit, cause the at least one processing circuit to:
stall transmission of any task, occurring after the first task, to the target device until the indication is received from the target device that all previously sent tasks have been processed.

23. The non-transitory processor-readable storage medium of claim 20, further having one or more instructions which, when executed by at least one processing circuit, cause the at least one processing circuit to:
send any task, occurring after the first task, to the target device once an indication is received from the target device that the first task has been processed.
